(19) United States
(12) Patent Application Publication
(10) Pub. No.: US 2006/0070948 A1
(43) Pub. Date: Apr. 6, 2006

(54) Aerobic bacterial generator for pond and fish culture facility water quality management

(76) Inventor: Daniel E. Wickham, Duncans Mills, CA (US)

Correspondence Address: Douglas S. Bishop;Bishop & Heintz, P.C., P.O. Box 707, Traverse City, MI, 49685-0707, US

(21) Appl. No.: 11/243,235

(22) Filed: Oct. 4, 2005

Related U.S. Application Data
(60) Provisional application No. 60/615,394, filed on Oct. 4, 2004.
(60) Provisional application No. 60/709,906, filed on Aug. 22, 2005.

(51) Int. Cl. C02F 3/02; C02F 3/04

(52) U.S. Cl. 210/610; 210/615; 210/629; 210/620

(57) ABSTRACT

The invention described herein provides a novel modification of an aerobic bacterial generator, typically used for sewage wastewater treatment. By providing a pre-filter one creates the equivalent of a “sub-gravel filter” known to the aquarium trade. In such fashion the device is portable and can be placed at the bottom of any pond, lake or other body of water to act as an aeration and biological filtration device. Further the unit incorporates a means of inoculation and maintenance of cultures of beneficial bacteria within the device to improve digestion of organic residues as well as to compete with algae for mineral nutrients, thereby preventing noxious blooms of plant material.

### RELATED APPLICATIONS

This application claims benefit of Provisional Patent Application No. 60/615,394, filed Oct. 4, 2004 and Provisional Patent application 60/709,906 filed Aug. 22, 2005.

### BACKGROUND OF THE INVENTION

1. Field of the Invention

The present invention relates to pond aerators and, in particular, to a type of aerator that enhances the growth of bacterial cultures beneficial to the maintenance of water quality in ponds or fish culture facilities.

2. Description of the Related Art

Ponds used for landscaping purposes or for the culture of aquatic plants or animals represent artificial environments that need to be managed in order to maintain water quality.

One of the most significant problems relating to water quality in such ponds is the buildup of mineral nutrients that stimulate the growth of plant materials such as algae. Such plants take advantage of these nutrients to foster the process of photosynthesis, through which the plants fix carbon from the atmosphere to form living cellular biomass.

As such living plant material accumulates, a byproduct of gaseous O₂ is released, increasing the dissolved oxygen in the water during periods of illumination. However, during non-illuminated periods these same organisms must consume oxygen for normal aerobic metabolism.

A problem in the aquatic environment is that water has a limited ability to absorb and hold dissolved O₂. Water at typical ambient temperatures is saturated with oxygen tensions ranging from only 7-10 mg/L. As algal cells accumulate, densities can be high enough to produce transient O₂ tensions during active photosynthesis in excess of 20 mg/L.

These plants utilize oxygen for the various non-photosynthetic metabolic processes as they produce oxygen through photosynthesis. During sunlight the amount of oxygen produced is more than sufficient to meet the needs of their aerobic metabolism. However, any oxygen produced beyond a tension of 7-10 mg/L escapes into the atmosphere and therefore will not be available to the algae during periods of darkness when no more O₂ is being released through photosynthesis.

Where nutrients stimulate the growth of sufficient biomass to require uptake of greater than the 7-10 mg/L available over the course of a nightly dark period, such plants can draw the dissolved oxygen concentration down effectively to zero. At such times aquatic animals, such as fish or crustaceans, being totally dependent on dissolved oxygen for survival, will die.

One means to deal with loss of dissolved O₂ in ponds or fish culture facilities is to actively aerate the ponds. A wide variety of means of delivering air exist. One such means involves pumping of the water so that it is exposed to air such that it takes up oxygen in dissolved form. This can be done by spraying the water into the air or allowing it to flow over complex surfaces that mix the water or allowing it to splash back into the pond as a waterfall.

Another means is to send air directly into the water via air pumps or compressors. This air can be delivered through pipes or hoses as coarse bubbles or it can be delivered through diffusers such as air stones or membrane diffusers that reduce bubble size, thereby increasing the transfer of O₂ to the water.

Another means of improving water quality beyond supplementing with O₂ is to use either biological, mechanical or chemical means to remove plant material that cause the oxygen depletion in the first place. One way to do this is to pass the water through porous media, either within the pond or aquarium, or outside the system. Such filtration will strain algal cells from the water but will not typically remove dissolved nutrients. These nutrients will allow regrowth of algae and plants in the system.

Such filtration, however, can be enhanced by allowing the filter media to build up a colony of bacteria. These bacteria provide several benefits. They consume all forms of organic wastes in the pond, converting it to CO2 gas that can then escaped from the pond. They also compete with the algae for the mineral nutrients, preventing excess photosynthesis. They also can convert nutrients, especially nitrogenous compounds to less toxic forms, as well as to N2 gas, thus allowing excess nitrogen to dissipate from the liquid.

One common means of implementing media based biological treatment is through the use of a “sub sand” or “sub gravel” filter. This involves creation of a space beneath a porous “false” bottom consisting of sand, gravel or other granular material. A pump can then pump water out of that space with replacement water thereby being drawn slowly through the bottom granular medium such that it contacts the bacterial film that typically colonizes such medium.

One method of pumping water from a sub sand filter is through the use of an “air lift” pump. This consists of a tube that passes through the false bottom into the space below. An air hose is placed inside the tube and air is pumped and released as a bubble stream at the base of the tube. As the bubbles rise through the tube they expand in size as the pressure reduces with depth. This pushes water in front of the expanding bubbles and generates a current. As above, such water is replaced with water that diffuses slowly through the false bottom granular medium. Not only does such a device generate a water flow through the biological medium, it aerates the water as it does so.

The bacterial component of such systems can be allowed to develop in haphazard fashion through colonization with wild bacteria or it can be established using commercial strains as inoculants. One group of bacteria with beneficial properties is that of the “facultative bacteria”. These are predominantly aerobic species of bacteria but they also possess metabolic pathways that allow them to live in the absence of free O₂.

Certain species in the group Bacillus are spore formers so they can readily be obtained as stable commercial cultures. Other groups such as Pseudomonas are not spore formers but can be stabilized as vegetative cells making them also commercially available.

A device is described in U.S. Pat. No. 6,780,318 that encourages growth of such facultative bacteria in wastewater treatment applications. It is commercially marketed as an ABG or Aerobic Bacterial Generator. This device uses the airlift principle described above to aerate and pass wastewater over a matrix within the column on which bacteria can grow. The device further describes a means through which commercial cultures of desirable bacteria can be introduced.

An advantage of this device is that it is scalable such that small versions can be used in small treatment vessels while larger, more powerful versions can be used in larger applications.

A second advantage is that the unit is portable. It can be incorporated as an integral component of a wastewater treatment vessel or it can be added as a completely transportable retrofit into any form of liquid vessel.

A specialized use of an ABG is described in Non-Provisional Patent Application #f10/984,009, filed on Nov. 8, 2004 for the purpose of carrying out the biological denitrification of nitrogenous compounds typically found in wastewater. Further a method to enhance this reaction is described in Provisional Patent Application No. 60/616,961 and Provisional Patent Application No. 60/709,906.

There exists a need to combine the above described processes such that a simple device can provide the benefits of aeration, mechanical filtration, biological media filtration and bacterial supplementation in a single, portable system that can be economically installed in ponds or other fish culture applications.

### SUMMARY OF THE INVENTION

The present invention provides a method to treat water in a pond or fish culture facility so to improve clarity, preserve dissolved oxygen and prevent excessive blooms of noxious plant materials. The method includes the step of adding facultative bacteria to the pond or fish culture facility. The step of adding facultative bacteria includes the step of aerating and circulating the liquid in the pond or fish culture facility over a medium capable of supporting the growth of such bacteria.

The present invention also includes a method to enhance growth of a second group of bacteria that oxidizes ammonia compounds and acts in concert with the facultative bacteria to convert such oxidized nitrogen compounds to nitrogen gas so it can dissipate from the liquid.

The method also includes a means of delivering cultures of bacteria as well as specific nutrients to the system to supplement and control the bacterial colony existing in the system.

The present invention also includes an aerator and filtration device. The aerator/filtration device consists of a fine bubble diffuser at the base of a column which, when aerated, generates a water current through the column.

The column of the aerator/filtration device is filled with a matrix on which heterotrophic, facultative bacteria can attach and form a colony. Aerated water passing over this column exposes bacteria to nutrients and organic material contained in the pond or fish culture facility liquid.

The present invention also includes a method for introducing calcium carbonate material in the form of oyster shells, or other similar materials, within the column to act as a surface that stimulates growth and attachment of ammonia oxidizing autotrophic bacteria.

In the present invention the base of the column is surrounded and encompassed by a containment apparatus that acts as a pre-filter. This pre-filter contains a porous, fibrous matrix that mechanically filters incoming liquid and also supports the growth of attached facultative heterotrophic bacteria.

The method of the invention also includes a material consisting of calcium carbonate, in the form of crushed oyster shells or other similar materials, which stimulate colonization and growth of ammonia oxidizing bacteria in the external pre-filter.

In the present invention the diffuser within the aerator/filtration device is supplied with air from a remote air pump or compressor delivered through a pipe or hose connected from the pump to the diffuser.

The method also includes a hose passing from the surface down and into the pre-filter matrix portion of the device through which liquid cultures of facultative heterotrophic bacteria and/or ammonia oxidizing bacteria can be added as needed.

The method also provides a central tube within the column of the device that allows a porous packet of bacterial cultures to be added and held within the aerated water column generated by the airlift action.

### BRIEF DESCRIPTION OF THE DRAWINGS

FIG. 1 is a flow chart illustrating method 100 in accordance with the present invention.

FIG. 2 is a flow chart illustrating method 200 in accordance with the present invention.

FIG. 3 is a flow chart illustrating method 300 in accordance with the present invention.

FIG. 4 is a flow chart illustrating method 400 in accordance with the present invention.

FIG. 5 is a flow chart illustrating method 500 in accordance with the present invention.

FIG. 6 is a cross-sectional view illustrating an aeration/filtration device 600 in accordance with the present invention.

FIG. 7 is a cross-sectional view illustrating an aeration/filtration device 700 in accordance with the present invention.

FIG. 8 is a cross-sectional view illustrating an aeration/filtration device 800 in accordance with the present invention.

FIG. 9 is a cross-sectional view illustrating an aeration/filtration device 900 in accordance with the present invention.

FIG. 10 is a cross-sectional view illustrating an aeration/filtration device 1000 in accordance with the present invention.

### DETAILED DESCRIPTION

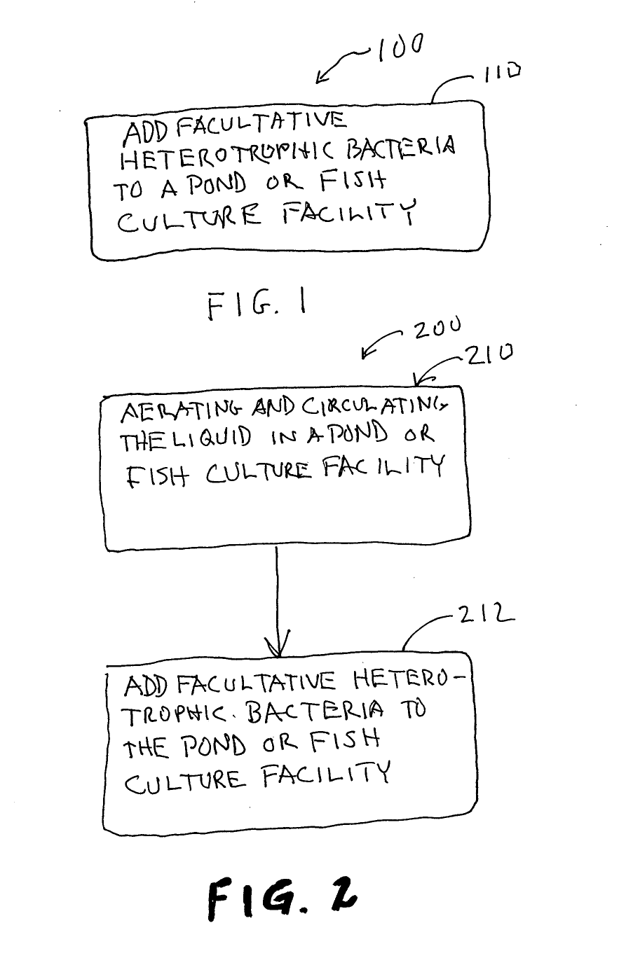

FIG. 1 shows a flow chart that illustrates a method 100 in accordance with the present invention. As shown in FIG. 1, method 100 has a single step 110 of adding facultative, heterotrophic bacteria and ammonia oxidizing bacteria to a pond or fish culture facility containing organic waste.

The liquid in the pond or fish culture facility contains nutrients that stimulate blooms of photosynthetic algae that can degrade water quality and depress the level of dissolved oxygen.

The facultative bacteria added to the pond or fish culture facility compete for nutrients and supplant the algal community and prevent the deterioration of water quality due to excessive photosynthetic loading to the pond or fish culture facility while the ammonia oxidizing bacteria can initiate conversion of ammonia to nitrogen gas in concert with the facultative heterotrophic bacteria.

FIG. 2 shows a flow chart that illustrates a method 200 in accordance with the present invention. Method 200 is an example of one way of implementing method 100. As shown in FIG. 2, method 200 begins at step 210 by aerating and circulating the liquid in a pond or fish culture facility that contains organic and mineral nutrients within the liquid.

Following this, method 200 moves to step 212 to add facultative bacteria such that the growth of the facultative bacteria is enhanced by the aeration and circulation of the liquid in the pond or fish culture facility. As a result of the aeration and circulation of the liquid the added bacteria will flourish and colonize surfaces within the pond or fish culture facility, thereby enhancing the bacteria's ability to digest organic and mineral nutrients within the liquid.

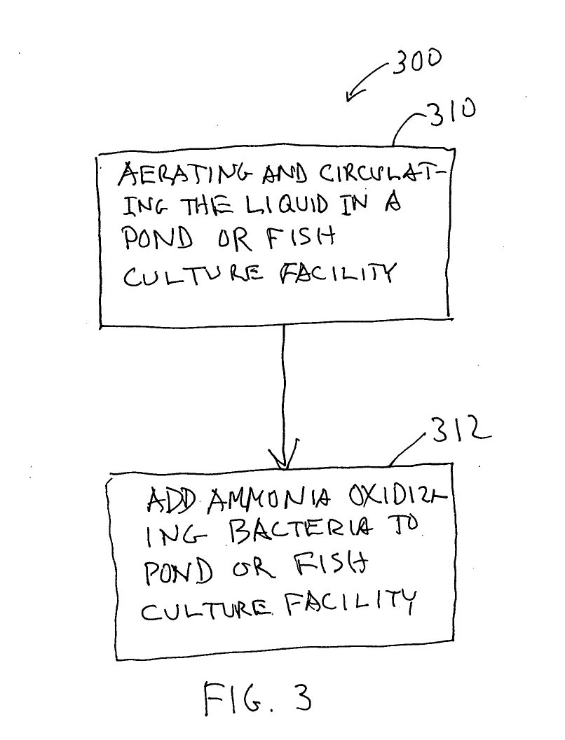

FIG. 3 shows a flow chart that illustrates a method 300 in accordance with the present invention. Method 300 is an example of implementing method 100. As shown in FIG. 3, method 300 begins at step 310 by aerating and circulating the liquid in a pond or fish culture facility that contains organic and mineral nutrients within the liquid.

Following this, method 300 moves to step 312 to add ammonia-oxidizing bacteria to the pond or fish culture facility. The ammonia oxidizing bacteria convert ammonia to nitrite and the facultative heterotrophic bacteria convert nitrite to gaseous nitrogen, which can dissipate from the liquid to the atmosphere.

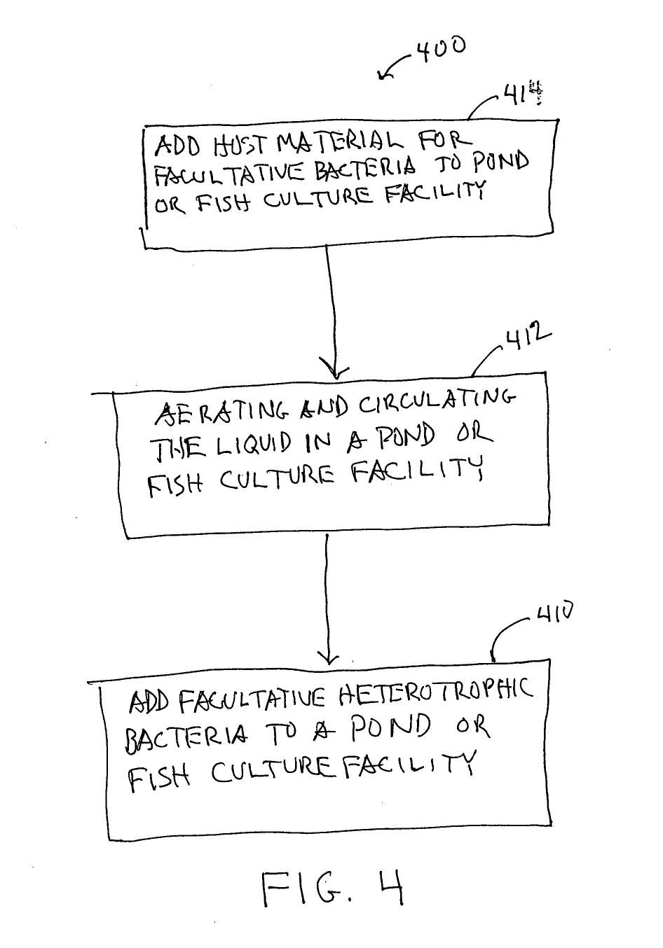

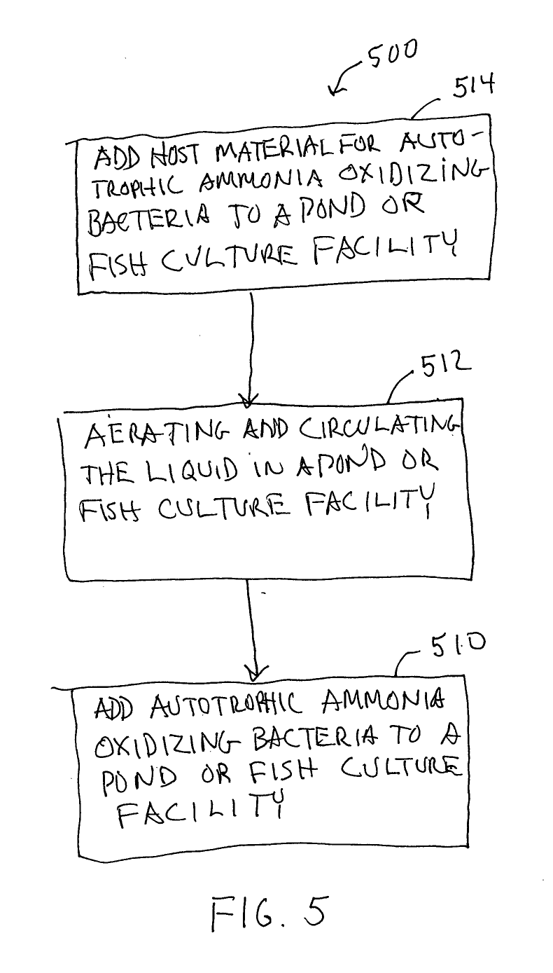

FIG. 4 shows a flow chart that illustrates a method 400 in accordance with the present invention. Method 400 is similar to method 200 and, as a result, utilizes the same reference numbers to designate the steps that are in common to both methods. As shown in FIG. 4, method 400 differs from method 200 in that method 400 includes step 410, which adds a host material for facultative heterotrophic bacteria to the pond or fish culture facility.

The host material for the facultative heterotrophic bacteria provides a surface for the bacteria to grow on that increases the number of facultative heterotrophic bacteria that are present in the pond or fish culture facility. In the preferred embodiment, the bacterial host material is placed adjacent to the aeration source so that the bacterial host material is bathed in air and waste material when the aeration source is in operation.

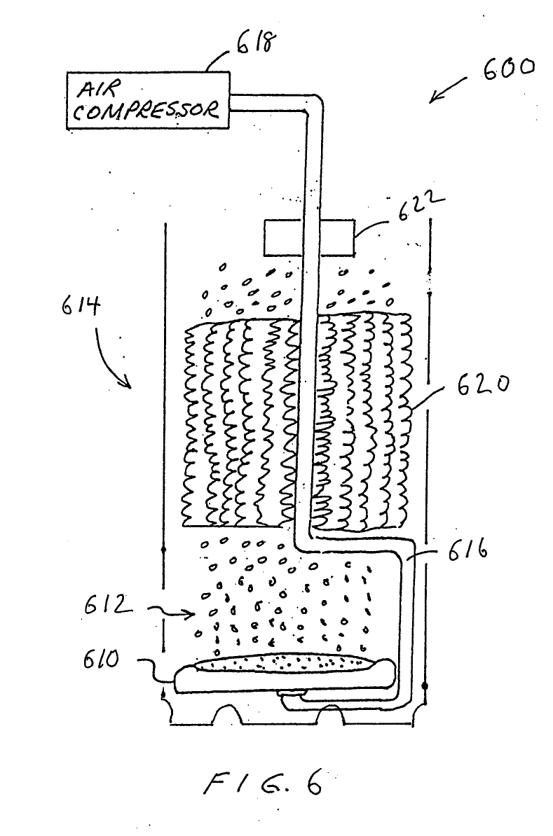

FIG. 5 shows a flow chart that illustrates a method 500 in accordance with the present invention. Method 500 is similar to method 300 and, as a result, utilizes the same reference numbers to designate the steps that are in common to both methods. As shown in FIG. 5, method 500 differs from method 300 in that method 500 includes step 510, which adds a host material for ammonia oxidizing bacteria to the pond or fish culture facility.

The host material for the ammonia oxidizing bacteria provides a surface for the bacteria to grow on that increases the number of ammonia oxidizing bacteria that are present in the pond or fish culture facility. In the preferred embodiment, the bacterial host material is placed adjacent to the aeration source so that the bacterial host material is bathed in air and waste material when the aeration source is in operation.

Further the host material for the ammonia oxidizing bacteria is placed adjacent to the host material for the facultative heterotrophic host material so that as ammonia is oxidized by the ammonia oxidizing bacteria to nitrite, the nitrite is readily available to the facultative heterotrophic bacteria so that they can convert the nitrite to nitrogen gas. In such fashion the nitrogen can readily dissipate from the liquid.

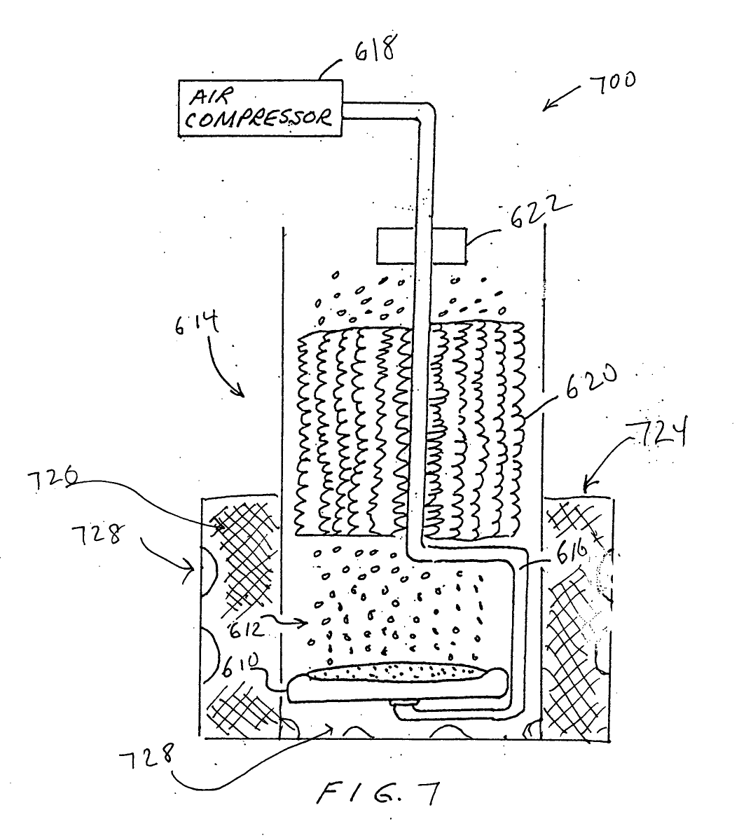

FIG. 6. shows a cross sectional view that illustrates an aerator/filtration device 600 in accordance with the present invention. Aerator/filtration device 600 is an example of a device that can be used to implement the methods of the present invention.

As shown in FIG. 6, aerator/filtration device 600 includes and air diffuser 610 that aerates and circulates the liquid in a pond or fish culture facility. Diffuser 610 has an air input side and a bubble output side. In addition, diffuser 610 provides bubbles of air 612 evenly across the diameter of a column 614 that extends away from the bubble output side of the diffuser 610. Diffuser 610 can provide micro-fine, fine, medium, or course bubble sizes.

Aerator/filtration device 600 also includes a compressed air line 616 that is connected to the air input side of air diffuser 610, and an air compressor (or blower) 618 that is connected to the compressed air line 616. Compressor 618, which is located a distance away from diffuser 610, can be implemented with, for example an 80-watt compressed air pump. Line 616 provides diffuser 610 with pressurized air pumped from compressor 618.

In the example shown in FIG. 6, line 616 extends around from the input side to the bubble side of air diffuser 610, and then extends away from the bubble side in column 614 that extends away from diffuser 610. Diffuser 610 is preferably implemented with a micro-fine bubble diffuser because a micro-fine diffuser can inject more oxygen into a stream of liquid at a lower air pressure, which, in turn, lowers the operating requirements of compressor 618.

Aerator/filtration device 600 optionally includes a bacterial host material 620 that is positioned within the column 614 that extends away from diffuser 610. Material 720 is positioned a predetermined distance away from the bubble output side of the diffuser 610, measured normal to the surface of the bubble output side. Material 620 can be any material that provides a surface area for bacteria to grow and that water can pass through without clogging.

Material 620 is preferably manufactured from a material that is resistant to decay, and configured and placed within the column in a fashion that provides the maximum possible film forming surface area with the volume of the column. Material 620 is placed to allow for the free flow of both liquid and air through material 620. For example, material 620 can be implemented with a sheet of cuspated plastic material manufactured similar to the method described in U.S. Pat. No. 4,449,072, which is hereby incorporated by reference.

Aerator/filtration device 600 additionally includes a bacteria container/applicator 622 that is positioned within column 614 that extends away from diffuser 610. Container 622 is positioned a predetermined distance away from the bubble output side of diffuser 610, measured normal to the surface of the bubble output side. Bacteria container/applicator 622 includes a porous sack, or any other similar packaging, which can contain a bacterial starter culture allowing timed release of viable bacteria over a prolonged period or the outlet end of a tube or other means to deliver bacteria from an external source.

To maintain the position of bacterial host material 620 and bacterial container/applicator 622 within the column that extends away from diffuser 610, material 620 and container/applicator 622 can be connected to airline 616. Alternately, device 600 can include a frame or structure to provide the necessary positional relationships.

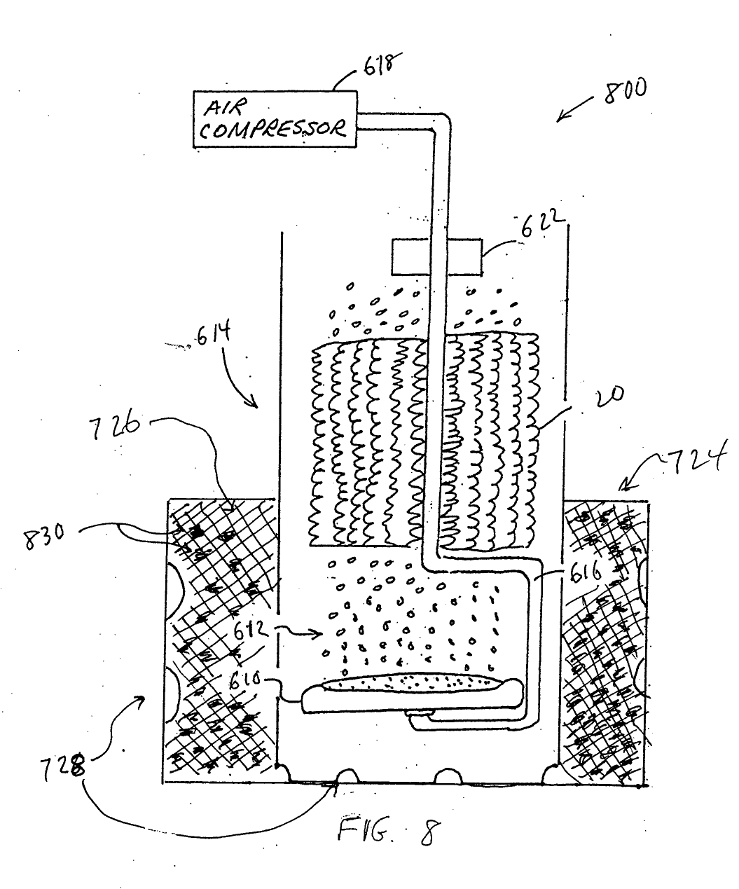

FIG. 7 shows a perspective view that illustrates an aerator/filtration device 700 in accordance with the present invention. Device 700 is similar to device 600 and, as a result, utilizes reference numerals to designate the structures, which are common to both devices.

As shown in FIG. 7, aerator/filtration device 700 differs from device 600 in that the base of the column 714 is surrounded by an external pre-filter device 724 through which liquid must pass to enter the aerator/filtration device 700. In the preferred embodiment pre-filter device 724 is filled with a material 726 similar to that used for furnace or air conditioner filters, or any material that provides porosity while at the same time being sufficiently dense to provide mechanical filtration and act as a matrix for bacterial colonization.

Pre-filter 724 is a closed unit that is perforated with openings 728 to allow liquid to enter into the device through the majority of the filter material 726 as it passes into the zone of the air diffuser 610 and into the column 614 which extends away from diffuser 610 and over the material 620 within the column that acts as a matrix for bacterial settlement and past container 622 that contains a bacterial culture.

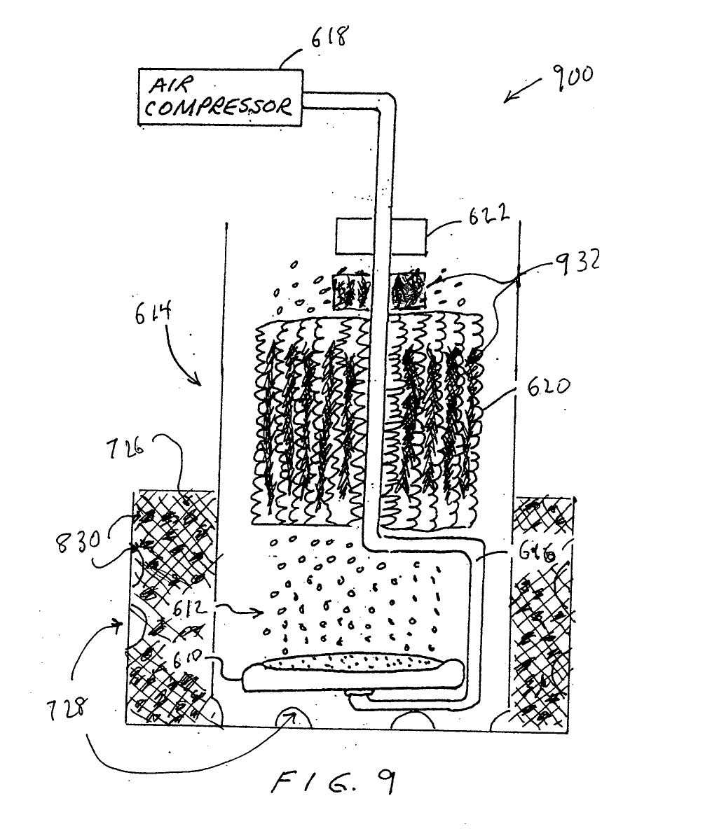

FIG. 8 shows a perspective view that illustrates an aerator/filtration device 800 in accordance with the present invention. Device 800 is similar to device 700 and, as a result, utilizes reference numerals to designate the structures, which are common to both devices.

As shown in FIG. 8, aerator/filtration device 800 differs from device 700 in that a second material 830 is added to the filter material 726, either loosely or as a separate container, that consists of calcium carbonate derived from crushed oyster shells or similar material that stimulates the settlement and growth of autotrophic ammonia oxidizing bacteria to act in concert with facultative heterotrophic bacteria introduced to the aeration/filtration device 800 via the container 622 containing such culture.

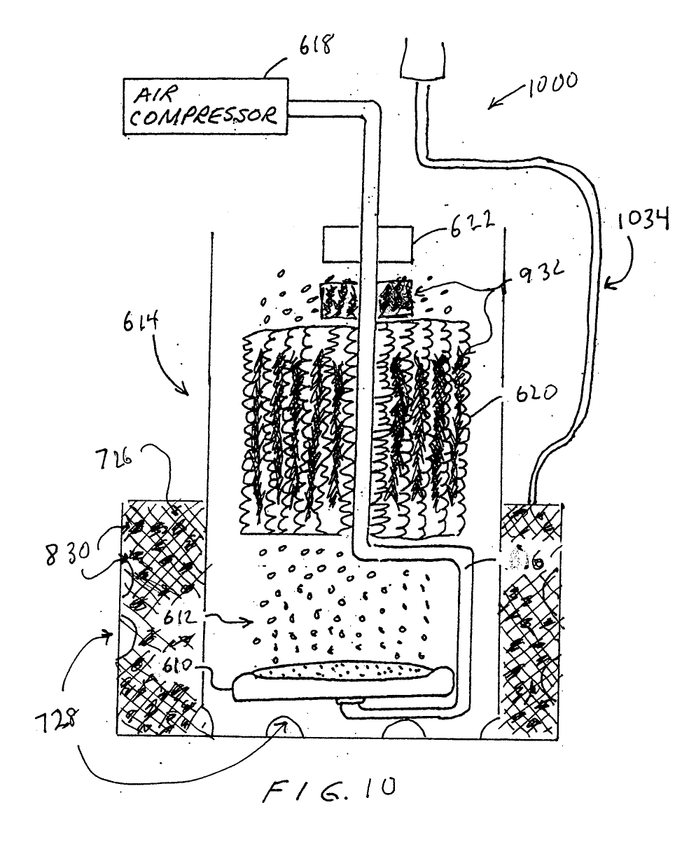

FIG. 9 shows a perspective view that illustrates an aerator/filtration device 900 in accordance with the present invention. Device 900 is similar to device 800 and, as a result, utilizes reference numerals to designate the structures, which are common to both devices.

As shown in FIG. 9, aerator/filtration device 900 differs from device 800 in that a second material 932 is placed adjacent to material 820 within the column 614 which extends away from diffuser 610, either loosely or as a separate container, that consists of calcium carbonate derived from intact or crushed oyster shells or similar material that stimulates the settlement and growth of autotrophic ammonia oxidizing bacteria to act in concert with facultative heterotrophic bacteria introduced to the aeration/filtration device 900 via the container 622 containing such culture.

FIG. 10 shows a perspective view that illustrates an aerator/filtration device 1000 in accordance with the present invention. Device 1000 is similar to device 900 and, as a result, utilizes reference numerals to designate the structures, which are common to both devices.

As shown in FIG. 10, aerator/filtration device 1000 differs from device 900 in that a second means of introducing both heterotrophic facultative bacteria and autotrophic ammonia oxidizing bacteria is provide by a hose 1032 that passes from any place outside the pond or fish culture facility and terminates either within the filter material 726 and 1028 within the pre-filter 1024 or adjacent to container 1022 inside column 1014 which extends away from diffuser 1010 or at both locations such that a liquid bacterial culture consisting of either facultative heterotrophic bacteria or autotrophic ammonia oxidizing bacteria, or both, can be passed through hose 1032 from a remote location.

What is claimed is:

1. A method of managing pond or fish culture facility water quality, the method comprising the steps of:
aerating and circulating the liquid in the pond or fish culture facility to facilitate the growth of facultative heterotrophic bacteria and autotrophic ammonia oxidizing bacteria added to the liquid in the form of an inoculum or allowed to develop naturally over the course of time.

2. The method of claim 1 wherein the added culture of facultative heterotrophic and bacteria act to prevent excessive growth of photosynthetic algae and plants by competing for nutrients necessary to the survival of both types of organism.

3. The method of claim 2 wherein the added culture of facultative heterotrophic bacteria facilitate the digestion of organic materials in the liquid thereby preventing depletion of dissolved oxygen in the liquid, which would result from the build-up of such organic detritus over time.

4. The method of claim 1 wherein the added culture of autotrophic ammonia oxidizing bacteria or such bacteria that develop as a consequence of introduction of ambient vegetative cells through the air stream used to aerate and circulate the liquid act in concert with the heterotrophic facultative bacteria to convert ammonia and other nitrogenous compounds to gaseous forms of nitrogen that will dissipate from the liquid in the pond or fish culture facility.

5. The method of claim 1 wherein the step of aerating and circulating the liquid in a pond or fish culture facility is performed with an aerator bubbling air in the pond or fish culture facility.

6. The method of claim 5 wherein the diffuser used to bubble air in the pond or fish culture facility is contained in a column which generates a current through the action of the rising bubbles contained within the column.

7. The method of claim 6 wherein the current generated within the air column passes liquid from the pond or fish culture facility over a host material within the column that acts as a surface on which heterotrophic facultative and autotrophic ammonia-oxidizing bacteria can grow.

8. The method of claim 7 wherein the current passing over the bacterial host material in the aeration device draws organic and nitrogenous compounds in the liquid within a pond or fish culture facility over the attached bacterial colony such that these same bacteria act to remove such compounds from the liquid stream.

9. The method of claim 6 wherein an external pre-filter is placed to surround the inlet portion of the column such that the liquid current entering the device must pass through the pre-filter before entering and passing through the column.

10. The method of claim 9 wherein the pre-filter is filled with porous material that acts as both a mechanical filter as well as a host material for colonization by bacteria added to the liquid in the pond or fish culture facility.

11. The method of claim 7 wherein a second host material, consisting of calcium carbonate in the form of whole or crushed oyster shells, or similar material is contained within the column.

12. The method of claim 11 wherein the second host material specifically acts a medium for the growth of autotrophic ammonia oxidizing bacteria and stimulates colonization by autotrophic oxidizing bacteria.

13. The method of claim 10 wherein a second host material, consisting of calcium carbonate in the form of whole or crushed oyster shells, or a similar material is added to the host material within the pre-filter of the aeration device.

14. The method of claim 6 wherein the current generated in the air column passes over a container which holds a packet of facultative heterotrophic and/or autotrophic ammonia oxidizing bacterial cultures which acts to provide a continuous source of bacterial propagules to the liquid in a pond or fish culture facility.

15. The method of claim 5 wherein a hose is introduced into either the pre-filter portion of the device or adjacent to the air diffuser within the device and passes outside of the pond or fish culture facility so that liquid cultures of facultative heterotrophic and/or autotrophic ammonia-oxidizing bacteria can be supplied to the aeration device from a remote location.
